(19) United States
(12) Patent Application Publication
(10) Pub. No.: US 2023/0093326 A1
(43) Pub. Date: Mar. 23, 2023

(54) Polyester Carbonates on the Basis of Cycloaliphatic Diacids, 1,4:3,6-Dianhydrohexitol and Specific Amounts of an Additional Aliphatic Dihydroxy Compound

(71) Applicant: Covestro Deutschland AG, Leverkusen (DE)

(72) Inventors: Alexander Meyer, Düsseldorf (DE); Lukas Fabian Schulz, Lemgo (DE); Thomas Pfingst, Tönisvorst (DE)

(21) Appl. No.: 17/919,146

(22) PCT Filed: Jun. 11, 2021
(86) PCT No.: PCT/EP2021/065743

§ 371 Date: Oct. 14, 2022

(30) Foreign Application Priority Data
Jun. 19, 2020 (EP) 20181053.8

(51) Int. Cl. C08G 63/672

(52) U.S. Cl. CPC C08G 63/672

(57) ABSTRACT

The present invention relates to a process for preparing a polyester carbonate on the basis of cycloaliphatic diacids and at least one 1,4:3,6-dianhydrohexitol and at least one additional aliphatic dihydroxy compound, to the polyester carbonate prepared according to the process and to a molding compound and a molding body containing the polyester carbonate. The process according to the invention is a direct synthesis, in which all structural elements forming the subsequent polyester carbonate are present as monomers already in the first process step. It is characterized in that a specific ratio of 1,4:3,6-dianhydrohexitol and the at least one additional aliphatic dihydroxy compound is advantageous.

### CROSS-REFERENCE TO RELATED APPLICATIONS

This application is the United States national phase of International Application No. PCT/EP2021/065743 filed Jun. 11, 2021, and claims priority to European Patent Application No. 20181053.8 filed Jun. 19, 2020, the disclosures of which are hereby incorporated by reference in their entirety.

### BACKGROUND OF THE INVENTION

### Field of the Invention

The present invention relates to copolyester carbonates from cycloaliphatic diacids and 1,4:3,6-dianhydrohexitols containing a specific amount of additional aliphatic diol and to a process for producing the corresponding polyester carbonates.

### Description of Related Art

Polyesters, polycarbonates, and polyester carbonates are known to have good mechanical properties and good stability to heat distortion and to weathering. Depending on the monomers used, each polymer group has certain key features that characterize materials of this type. For instance, polycarbonates have in particular good mechanical properties, whereas polyesters often exhibit better chemical stability. Polyester carbonates, depending on the monomers selected, exhibit property profiles from both of said groups.

Although aromatic polycarbonates or polyesters often do have a good property profile, they exhibit shortcomings in their stability to aging and to weathering. For example, absorption of UV light leads to yellowing and sometimes embrittlement of these thermoplastic materials. Aliphatic polycarbonates and polyester carbonates have better properties in this respect, in particular better stability to aging and/or to weathering and better optical properties (for example transmission).

The drawback with aliphatic polycarbonates or polyester carbonates is often the low glass transition temperature thereof. It is accordingly advantageous to use cycloaliphatic alcohols as (co)monomers. Examples of such cycloaliphatic alcohols are TCD alcohol (tricyclodecanedimethanol; 8-(hydroxymethyl)-3-tricyclo[5.2.1.02,6]decanyl]methanol), cyclohexanediol, cyclohexanedimethanol, and biobased diols based on 1,4:3,6-dianhydrohexitols such as isosorbide and the isomers isomannide and isoidide. To raise the glass transition temperature further, cycloaliphatic acids such as cyclohexane-1,2-, -1,3- or -1,4-dicarboxylic acids or corresponding naphthalene derivatives can also be used as (co)monomers. Depending on the choice of reactants, polyesters or polyester carbonates are then obtained. This application relates to copolyester carbonates based on 1,4:3,6-dianhydrohexitols such as isosorbide or isomers thereof and also to cycloaliphatic diacids that contain specific amounts of further diols in order to achieve improved properties. The invention further relates to a process for producing said copolyester carbonates, the characteristic feature thereof being the direct reaction of the raw materials and that it does not require any raw materials that are difficult to handle, such as phosgene.

The polyesters of cyclohexanedicarboxylic acid and isosorbide are described by Oh et al. in Macromolecules 2013, 46, 2930-2940, whereas the present invention is by preference directed to polyester carbonates.

Polyesters are produced industrially for example by transesterification of corresponding ester-containing monomers with diols. For instance, the polyester of cyclohexane-1,4-dimethanol and cyclohexane-1,4-dicarboxylic acid is produced starting from the dimethyl ester of the diacid (blend of this polyester and polycarbonate: Xyrex® from DuPont).

For the transesterification reaction, phenyl esters are however significantly more reactive than their aliphatic analogs. EP 3026074 A1 and EP 3248999 A1 describe processes for producing polyester carbonates having phenyl esters as an intermediate step.

Example 1 of EP 3026074 A1 describes the direct reaction of the diacid with phenol to form the corresponding ester. In example 2 of EP 3026074 A1, a dimethyl ester is reacted with phenol. The yield for both phenyl ester production variants is however capable of being improved further. This then followed by production of the polyester carbonate. This document thus describes a two-step process that has the corresponding disadvantages of multiple steps, such as the complexity, the increased price, the need for multiple purification steps, etc.

EP 3248999 A1 describes the production of a diphenyl ester in a solvent and with the use of phosgene. Given that the subsequent reaction to form the aliphatic polyester carbonate does not involve the use of phosgene, the combination of a phosgene process with a transesterification process in the same part of a plant is very disadvantageous. The process described in EP 3248999 A1 is accordingly suboptimal too. Here too, a two-step process is described.

Two-step processes are likewise described in WO2020/085686 A1, WO 2019/093770 A1 (EP3708601A1), and WO2019/147051 A1. This means that all these documents always describe the reaction of a diacid to afford an ester. The ester initially isolated is then converted into a polyester carbonate.

US 2009/105393 A1 discloses an isosorbide-based polycarbonate consisting of an isosorbide unit, an aliphatic unit derived from an aliphatic C14 to C44 diacid, from an aliphatic C14 to C44 diol or from a combination thereof, and optionally an additional unit that is different from the isosorbide unit and from the aliphatic unit, wherein the isosorbide unit, the aliphatic unit, and the additional unit are each carbonates or a combination of carbonate and ester units. The frequent disadvantages of aliphatic polycarbonates or polyester carbonates have already been discussed above. In the examples, no polymers derived from a combination of isosorbide, a cycloaliphatic diacid, and additionally an aliphatic diol are produced. In addition, an activated carbonate is used in the transesterification.

In Kricheldorf et al. (Macromol. Chem. Phys 2010, 211, 1206-1214) it is reported that a polyester based on cyclohexanedicarboxylic acid and isosorbide is not obtainable from cyclohexanedioic acid or from the cyclohexane dimethyl ester (or gives only very low molecular weights) and can be produced only from the acid chloride of cyclohexanedicarboxylic acid.

The easy preparation of aromatic polyester carbonates is described for example in WO 01/32742 A1. This describes a direct synthesis or one-pot synthesis, i.e. a synthesis in which all the structural elements that form the subsequent polyester carbonate are already present as monomers at the start of the synthesis. Aromatic dihydroxy compounds such as bisphenol A, carboxylic diesters, and aromatic or linear aliphatic diacids are used as monomers here. Because this document is limited to the preparation of aromatic polyester carbonates, it is possible for temperatures of 300° C. to be employed in the condensation reaction in which the phenol that is formed is removed. The use of such temperatures is not possible when preparing aliphatic polyester carbonates, since aliphatic diols tend to undergo elimination and/or thermal decomposition when subjected to such thermal stress. At the same time, the high temperature is however necessary in order to grow to the desired high molecular weights. What is particularly clear here is the differing reactivity of aliphatic and aromatic diols. For example, it is known from the literature that isosorbide rarely undergoes complete incorporation into a polymer, with up to 25% of the isosorbide instead being lost during the polymerization reaction, depending on the chosen reaction conditions. It is accordingly not readily possible to extrapolate the reaction conditions for aromatic diols to aliphatic diols. This is in particular evident from the fact that the reaction times of the polycondensation (corresponding to process step (ii)) in WO01/32742 A1 are appreciably longer at higher temperatures than those observed in accordance with the invention.

JP1992-345616 A and DE2438053 A1 likewise use aromatic structural units and correspondingly high temperatures. For the reasons mentioned above, extrapolation of the teachings therein to aliphatic structural units is not possible.

US2004/092703A1 describes a process for producing polyesters containing an isosorbide unit. In this process, the isosorbide should be added to existing reactors in the simplest possible way, which is why it is dissolved in water. This document thus firstly relates exclusively to the production of polyesters and additionally requires the presence of a solvent.

The as yet unpublished application PCT/EP2019/084847 discloses a one-pot synthesis of a polyester carbonate, comprising a cycloaliphatic dicarboxylic acid, a diaryl carbonate, and an aliphatic dihydroxy compound.

The polyester carbonates described in EP 3026074 A1 and in EP 3248999 A1 have high glass transition temperatures. However, the structure of these polyester carbonates is very rigid. This is a consequence in particular of the isosorbide structure condensed into the polymer chain. The rigid character of the bicyclic substructure increases the glass transition temperature but makes the polymer chain very inflexible, which can in principle lead to disadvantages. Park et al report that the molecular weight decreases with higher amounts of isosorbide in the polymer (S. A. Park et al. Polymer 2017, 116, 153-159; pp. 155-156). The authors report that an increase in the molecular weight is prevented by the high melt viscosity. If a critical molecular weight is not reached, this can lead to inadequate mechanical properties. This is important particularly in the case of inflexible polymer chains. Rigid chains need to have a relatively high molecular weight in order to be able to become entangled. If this does not happen, brittle behavior results (critical entanglement molecular weight).

Although the cyclohexane dicarboxylic acid increases the flexibility somewhat, the overall structure of the polymer chain remains quite rigid. This can result in disadvantages during production of the polymers. The inflexible character makes it more difficult, as the molecular weight increases, for the reactants (chain ends) to find one another. As described above, this limits the molecular weight. Moreover, the rigid character causes a sharp increase in viscosity during polymer synthesis. To compensate for this, during polymer production the temperature is often increased in the end phase of the polycondensation so as to achieve better flowability. However, this is possible only to a limited extent in the case of aliphatic polymers, since the thermal stability is significantly lower compared to aromatic polyesters or polycarbonates, for example. The increasing viscosity, which cannot be compensated by increasing the temperature, results in poor mixing and poor surface renewal. The removal of condensation products (such as phenol) may then no longer be possible and the polycondensation stops.

As a means of creating better surface renewal, WO2019147051 A1 describes the use of horizontal polymer reactors such as polymer kneaders. These exert high shear forces on the polymer, increasing surface renewal and allowing the polycondensation to continue. However, the high shear forces place enormous stress on the inflexible polymer.

The high shear stress can thus result in damage, which may be manifested in a noticeable worsening in optical and mechanical properties.

### SUMMARY OF THE INVENTION

Starting from this prior art, the object of the present invention was therefore to provide a process for producing polyester carbonates, comprising at least one 1,4:3,6-dianhydrohexitol and at least one cycloaliphatic dicarboxylic acid, said process being characterized by good surface renewal during production. Better surface renewal is evidenced by, for example, higher achievable molecular weights. In particular, it should be possible therewith to achieve sufficiently high molecular weights in the polyester carbonates. “Sufficiently high molecular weights” is preferably understood as meaning a polymer having a relative solution viscosity of above 1.22, preferably of 1.25 to 1.65, more preferably 1.28 to 1.63, and particularly preferably 1.30 to 1.62, in each case measured in dichloromethane at a concentration of 5 g/l at 25° C. using an Ubbelohde viscometer. The polyester carbonates of the invention should in addition thus have better processing properties and good mechanical properties. A further object was to provide the simplest possible process for producing polyester carbonates by means of melt transesterification. In this context, “simple” is to be understood in particular as meaning a process that requires only modest outlay on equipment, involves few steps, in particular purification steps, and/or is accordingly economically and also environmentally advantageous. In particular, the process of the invention should manage without starting materials that are difficult to handle, in particular phosgene.

At least one, preferably all, of the abovementioned objects have been achieved by the present invention. What was surprisingly found to be possible was the synthesis of a polyester carbonate from at least one cycloaliphatic diacid, at least one diaryl carbonate, at least one 1,4:3,6-dianhydrohexitol, and at least one further aliphatic dihydroxy compound by means of melt transesterification in a direct synthesis or one-pot synthesis in which all the structural elements that form the subsequent polyester carbonate are already present as monomers at the start of the synthesis. However, it was found that a polymer having the appropriate molar mass and thus also the appropriate mechanical properties is obtained only when a specific amount of the at least one further diol is used. On the one hand, it was surprising that a direct synthesis, despite the described preconceptions of the prior art, also works for the reaction of a cycloaliphatic dicarboxylic acid, a 1,4:3,6-dianhydrohexitol, and at least one further aliphatic dihydroxy compound (also termed “aliphatic diol” in accordance with the invention), and a diaryl carbonate. It was also a complete surprise that the amount of the least one further aliphatic dihydroxy compound is important in order to obtain a good increase in molecular weight. This led to the discovery of a process that provides access to a polyester carbonate from cycloaliphatic diacids, a 1,4:3,6-dianhydrohexitol, and at least one further aliphatic dihydroxy compound and that is particularly simple, i.e. it requires only modest outlay on equipment, involves few steps, in particular purification steps, and is accordingly economically and also environmentally advantageous.

It was in addition found that the incorporation of small amounts of additional aliphatic dihydroxy compounds, in particular the incorporation of branched aliphatic dihydroxy compounds, increases surface renewal during the synthesis. What was surprising was that even the incorporation of small amounts of additional diols significantly increases surface renewal and thus the molecular weight. It was particularly surprising to find that branched diols readily condense into the polymer chain despite the steric hindrance. Those skilled in the art would have expected steric hindrance to hinder the increase in molecular weight. In addition, a new polyester carbonate has been obtained that has a different structure, i.e. a different statistical distribution of the structural elements, than the polyester carbonates previously described in the prior art.

The process for producing a polyester carbonate of the invention can be described schematically, for example by the reaction of cyclohexanedicarboxylic acid, isosorbide, an additional diol HO—R—OH, and diphenyl carbonate, as shown below:

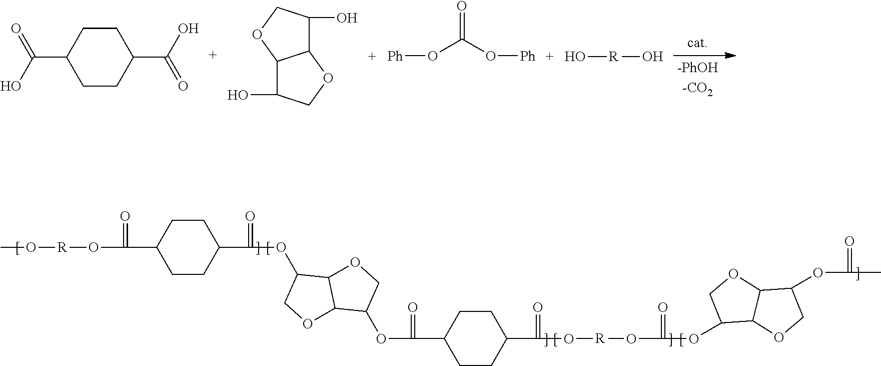

(the citing of these particular three starting substances is purely for the purposes of elucidating the invention and is not to be understood as limiting).

In the direct synthesis according to the invention, an evolution of gas was initially observed (evolution of carbon dioxide). If a sample is taken from the mixture once the evolution of gas has largely subsided, it can be demonstrated analytically that oligomers have already formed. These oligomers undergo condensation in a further step to form the polyester carbonate of the invention. The examples according to the invention show that the statistical distribution of the carbonate blocks and of the ester blocks (see scheme above) in these oligomers is already different from a purely statistical distribution of the blocks when only one derivative of cyclohexanedicarboxylic acid reacts with diphenyl carbonate, isosorbide and a further diol (by way of example) as in the prior art. In addition, the reactivity of such oligomers is different from that of pure cyclohexane diphenyl esters, isosorbide, further diols, and pure diphenyl carbonate. The net result of the process of the invention is therefore to obtain a polymer in which the statistical distribution of the different blocks differs from that of a polymer obtained from a cyclohexane diphenyl ester, isosorbide, a further diol, and diphenyl carbonate.

The invention therefore provides a process for producing a polyester carbonate by melt transesterification, comprising the steps of:
(i) reacting at least one cycloaliphatic dicarboxylic acid with at least one diaryl carbonate using at least one catalyst and in the presence of a mixture of dihydroxy compounds comprising (A) at least one 1,4:3,6-dianhydrohexitol and (B) at least one further aliphatic dihydroxy compound, and
(ii) subjecting the mixture obtained from step (i) of the process to further condensation, at least with removal of the chemical compound eliminated in the condensation,
   characterized in that the mixture of dihydroxy compounds comprises

98 mol % to 75 mol %, preferably 97 mol % to 80 mol %, particularly preferably 96 mol % to 82 mol %, of component (A) and

2 mol % to 25 mol %, preferably 3 mol % to 20 mol %, particularly preferably 4 mol % to 18 mol % of component (B),

in each case based on the sum of components (A) and (B).

It was surprisingly found that if the amount of the at least one further aliphatic dihydroxy compound is within the range defined in the claims, the increase in molecular weight takes place particularly readily. If the amount of the at least one further aliphatic dihydroxy compound is higher, there is surprisingly only a small increase in molecular weight. It was in addition advantageous when the at least one further dihydroxy compound has 2 to 11, preferably 3 to 10, carbon atoms.

According to the invention, step (i) of the process comprises at least the reaction of at least one cycloaliphatic dicarboxylic acid with at least one diaryl carbonate. However, in accordance with the invention, the presence of the at least one 1,4:3,6-dianhydrohexitol (hereinafter also component (A)) and the at least one further aliphatic dihydroxy compound (hereinafter also component (B)) means that the possibility of further reaction cannot be ruled out. In fact, it was demonstrated in the examples that already in step (i) of the process oligomers form that have a mass difference in the MALDI-TOF mass spectrometer corresponding to a unit consisting of component (A) and/or component (B) plus carbonate (with the loss of both hydroxy groups). This means that in step (i) of the process it is possible for further reaction besides the formation of the diester to take place. In accordance with the invention, this does however also mean that the reaction of all the cycloaliphatic dicarboxylic acid present with the stoichiometric equivalent of diaryl carbonate does not need to have proceeded to completion before step (ii) of the process is initiated. It is however according to the invention preferable for process step (i) to be carried out for as long as it takes for the observed evolution of gas to have largely ceased, with process step (ii) initiated, for example by applying a negative pressure to remove the chemical compound eliminated in the condensation, only after this point has been reached. However, as already described above, it may not necessarily be possible in accordance with the invention to achieve a clear separation between steps (i) and (ii) of the process.

Process Step (i)

The process of the invention is referred to as a direct synthesis or one-pot synthesis, since in process step (i) all the structural elements that form the subsequent polyester carbonate are already present as monomers. This preferably means that, in accordance with the invention, all aliphatic dihydroxy compounds (in each case component (A) and (B)), all cycloaliphatic dicarboxylic acids, and also all diaryl carbonates are present in this step, even when there is more than just the dihydroxy compounds in components (A) and (B), one cycloaliphatic dicarboxylic acid and/or one diaryl carbonate. It is therefore according to the invention preferable that all monomers that are to undergo condensation to the polyester carbonate in process step (ii) are already present during process step (i). The invention likewise encompasses the embodiment in which a small proportion of the at least one diaryl carbonate is additionally added in process step (ii). This may be selectively employed to lower the terminal OH group content of the polyester carbonate that is formed.

Such an approach is described for example in JP2010077398 A. However, in order that all the structural elements that form the subsequent polyester carbonate are already present as monomers in process step (i) and that no further structural elements are added, it is necessary here that the at least one diaryl carbonate added in small amounts in process step (ii) is the same as the at least one diaryl carbonate present in process step (i). The process can in this sense therefore still be referred to as a direct synthesis or one-pot synthesis.

In addition, the invention does not exclude the presence in process step (i) of aromatic dihydroxy compounds and/or aromatic dicarboxylic acids. However, these are preferably present only in small proportions. In process step (i) it is particularly preferable that an aromatic dihydroxy compound (component (C)) is additionally present in a content of up to 20 mol %, more preferably up to 10 mol %, and very particularly preferably up to 5 mol %, based on the total molar amount of the dihydroxy compound used. The ratio of components (A) and (B) defined in the claims remains the same. In process step (i) it is likewise particularly preferable that an aromatic dicarboxylic acid is additionally present, optionally also in addition to the aromatic dihydroxy compound, in a content of up to 20 mol %, more preferably up to 10 mol %, and very particularly preferably up to 5 mol %, based on the total molar amount of the dicarboxylic acid used. In these cases, it is still preferable in accordance with the invention to refer to the product as an aliphatic polyester carbonate. It is however particularly preferable that no aromatic dihydroxy compound is used in process step (i). It is also preferable that no aromatic dicarboxylic acid is used in process step (i). Likewise, it is preferable that in process step (i) neither an aromatic dihydroxy compound nor an aromatic dicarboxylic acid is used. As a general rule, aromatic compounds reduce UV stability and weather resistance when present in polyester carbonates. This is particularly disadvantageous for outdoor uses. In addition, aromatic components in a polyester carbonate reduce the surface hardness of moldings produced therefrom, which may result in a need for coating. In addition, diphenyl esters of aromatic acids, which can arise as intermediates, are for example stable intermediates that can slow down the polycondensation. This means it may be necessary to use further, specific catalysts.

These additional aromatic dihydroxy compounds (component (C)) are preferably selected from the group consisting of bisphenol A, 1,1-bis(4-hydroxyphenyl)-3,3,5-trimethylcyclohexane, 4,4′-dihydroxybiphenyl (DOD), 4,4′-dihydroxydiphenyl ether (DOD ether), bisphenol B, bisphenol M, and bisphenols (I) to (III)

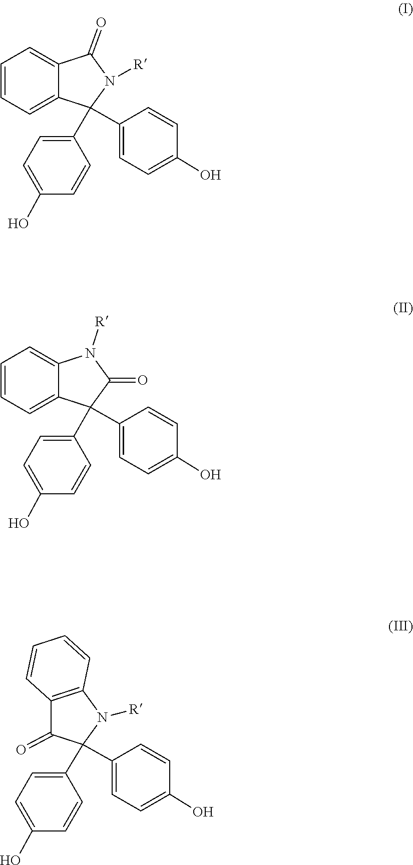

wherein, in these formulas (I) to (III), R′ in each case represents C1-C4 alkyl, aralkyl or aryl, preferably methyl or phenyl, very particularly preferably methyl.

These additional aromatic dicarboxylic acids are preferably selected from the group consisting of isophthalic acid, terephthalic acid, furan-2,5-dicarboxylic acid, and naphthalene-2,6-dicarboxylic acid. It is known that small proportions of these aromatic diacids can reduce the absorption of water by an aliphatic polyester carbonate.

According to the invention, at least one 1,4:3,6-dianhydrohexitol is used as component (A) in process step (i). As is known to those skilled in the art, 1,4:3,6-dianhydrohexitols are generally selected from the group consisting of isomannide, isoidide, and isosorbide. This can be a biobased structural element, with all the associated advantages of a biobased monomer and polymer resulting therefrom (for example better sustainability because it is obtainable from renewable raw materials). The process of the invention is particularly preferably characterized in that the at least one 1,4:3,6-dianhydrohexitol is isosorbide. It is preferable that component (A) consists of isosorbide.

According to the invention, at least one further aliphatic dihydroxy compound (component (B)) is used in process step (i). It is preferable that component (B) consists of two further aliphatic dihydroxy compounds. It is likewise preferable that component (B) consists of one further aliphatic dihydroxy compound. Thus, it is particularly preferable that component (A) consists of isosorbide and component (B) consists of a further aliphatic dihydroxy compound. A component (C) that includes an aromatic dihydroxy compound (see above) can optionally also be present in the mixture of dihydroxy compounds.

It is preferable that the at least one further aliphatic dihydroxy compound has the chemical formula (I):

HO—X—OH (I),

in which X is a linear alkylene group having 2 to 22, preferably 2 to 15, carbon atoms, more preferably 2 to 10 carbon atoms, which may optionally be interrupted by at least one heteroatom, a branched alkylene group having 4 to 20, preferably 5 bis 15, carbon atoms, which may optionally be interrupted by at least one heteroatom, or a cycloalkylene group having 4 to 20, preferably 5 to 15, carbon atoms, which may optionally be interrupted by at least one heteroatom and wherein the cycloalkylene group may optionally contain more than one ring and may in each case optionally be branched.

When X is in accordance with the invention a linear alkylene group that may optionally be interrupted by at least one heteroatom, it preferably has 2 to 15, particularly preferably 2 to 12, very particularly preferably 2 to 11, especially preferably 2 to 10, further preferably 2 to 6, and further preferably 3 to 4, carbon atoms. The heteroatom that may optionally interrupt the alkylene group is preferably oxygen or sulfur, more preferably oxygen. Particularly preferably, the alkylene group contains just one heteroatom or no heteroatom. When at least one heteroatom is present in the alkylene group, the stated number of carbon atoms relates to the total number of carbon atoms in the alkylene group. For example, the group —CH₂—CH₂—O—CH₂—CH₂— contains 4 carbon atoms. According to the invention, it is preferable that the linear alkylene group that may be interrupted by at least one heteroatom has fewer than 12, more preferably fewer than 10, carbon atoms. Particularly preferably, the alkylene group does not contain a heteroatom.

When X is in accordance with the invention a branched alkylene group having 4 to 20, preferably 5 to 15, carbon atoms, particularly preferably 5 to 11 carbon atoms, very particularly preferably 5 to 10 carbon atoms, that may optionally be interrupted by at least one heteroatom, the above statements apply to the heteroatom. The heteroatom that may optionally interrupt the branched alkylene group is preferably oxygen or sulfur, more preferably oxygen. Particularly preferably, the branched alkylene group contains just one heteroatom or no heteroatom. Particularly preferably, the branched alkylene group does not contain a heteroatom. The term “branched” is understood as referring to the branching in aliphatic carbon chains known to those skilled in the art. This means that the branched alkylene group preferably contains at least one tertiary and/or at least one quaternary carbon atom. It is possible for more than one branch to be present in the branched alkylene group. The branches preferably have chain lengths of 1 to 5 carbon atoms, particularly preferably 1 to 4, very particularly preferably 1 to 3, carbon atoms. These carbon atoms in the branches count towards the total number of carbon atoms in the branched alkylene group. This means for example that the branched alkylene group —CH₂—C(CH₃)₂—CH₂— contains 5 carbon atoms.

When X is in accordance with the invention a cycloalkylene group having 4 to 20, preferably 5 to 15, carbon atoms, which may optionally be interrupted by at least one heteroatom and wherein the cycloalkylene group may optionally contain more than one ring and may in each case optionally be branched, the above statements apply to the heteroatom. The heteroatom that may optionally interrupt the cycloalkylene group is preferably oxygen or sulfur, more preferably oxygen. Particularly preferably, the cycloalkylene group contains just one heteroatom or no heteroatom. Particularly preferably, the cycloalkylene group does not contain a heteroatom. Preferably, the cycloalkylene group contains at least one, preferably one, ring having 4 to 6 carbon atoms. In particular, it is preferable that the cycloalkylene group contains a total of 4 to 20, preferably 5 to 15, carbon atoms and a ring having 4 to 5 carbon atoms. The carbon atoms of the ring are included in the total number of carbon atoms in the cycloalkylene group. This means that a tetramethylcyclobutenyl group has a total of 8 carbon atoms, including a ring containing 4 carbon atoms. The cycloalkylene group may additionally contain at least one branch. This is particularly preferable. When branches are present, these may be in the cycloaliphatic chain optionally present and/or in the ring. Preferably, the branches are present in the ring. Preferably, X is a cycloalkylene group having 5 to 15 carbon atoms with one ring, said group optionally having at least one branch, preferably having at least one branch and at least one ring, preferably a ring having 4 to 6 carbon atoms, more preferably 4 to 5 carbon atoms.

Overall, it is according to the invention preferable that the at least one further aliphatic dihydroxy compound has 2 to 10 carbon atoms.

The process of the invention is particularly preferably characterized in that the at least one further aliphatic dihydroxy compound is selected from the group consisting of cyclohexane-1,2-diol, cyclohexane-1,3-diol, cyclohexane-1,4-diol, cyclohexane-1,2-dimethanol, cyclohexane-1,3-dimethanol, cyclohexane-1,4-dimethanol, 2,2-bis(4-hydroxycyclohexyl)propane, tetrahydrofuran-2,5-dimethanol, 2-butyl-2-ethylpropane-1,3-diol, 2-(2-hydroxyethoxy)ethanol, 2,2,4,4-tetramethylcyclobutane-1,3-diol, 2,2,4-trimethylpentane-1,3-diol, 2,2-dimethylpropane-1,3-diol, cyclobutane-1,1-diyldimethanol, 8-(hydroxymethyl)-3-tricyclo[5.2.1.02,6]decanyl]methanol, propane-1,2-diol, propane-1,3-diol, butane-1,4-diol, pentane-1,5-diol, hexane-1,6-diol, octane-1,8-diol, and any desired mixtures thereof. In particular, it is preferable that the at least one further aliphatic dihydroxy compound is selected from the group consisting of 2-butyl-2-ethylpropane-1,3-diol, 2-(2-hydroxyethoxy)ethanol, 2,2,4,4-tetramethylcyclobutane-1,3-diol, 2,2,4-trimethylpentane-1,3-diol, 2,2-dimethylpropane-1,3-diol, cyclobutane-1,1-diyldimethanol, propane-1,2-diol, propane-1,3-diol, butane-1,4-diol, pentane-1,5-diol, hexane-1,6-diol, octane-1,8-diol, and any desired mixtures thereof. Likewise, it is preferable that the at least one further aliphatic dihydroxy compound is selected from the group consisting of 2-butyl-2-ethylpropane-1,3-diol, 2,2,4,4-tetramethylcyclobutane-1,3-diol, 2,2,4-trimethylpentane-1,3-diol, 2,2-dimethylpropane-1,3-diol, cyclobutane-1,1-diyldimethanol, butane-1,4-diol, and any desired mixtures thereof. It is very particularly preferable that the at least one further aliphatic dihydroxy compound is selected from the group consisting of 2-butyl-2-ethylpropane-1,3-diol, 2,2,4,4-tetramethylcyclobutane-1,3-diol, 2,2,4-trimethylpentane-1,3-diol, 2,2-dimethylpropane-1,3-diol, cyclobutane-1,1-diyldimethanol, and any desired mixtures thereof.

It has in accordance with the invention been found that the additional at least one further aliphatic dihydroxy compound can under the reaction conditions of process step (i) of the invention react with the at least one diaryl carbonate also present. This is observed especially in dihydroxy compounds in which the two hydroxy groups are in close proximity to one other (e.g. 2 or 3 carbon atoms apart). Without being bound to a particular theory, an intramolecular carbonate that is no longer reactive appears to form. This means that this intramolecular carbonate no longer takes part in the reaction to form the polyester carbonate. The consequence of this is that the amount of the at least one further aliphatic dihydroxy compound that is added at the start of process step (i) does not always necessarily correspond to the amount of structural elements in the polyester carbonate derived from said dihydroxy compound. It will generally be lower, especially in the case of compounds that have two hydroxy groups in close proximity to one another. This does not apply in particular to cyclic dihydroxy compounds such as cyclohexanedimethanol. Methods for determining the proportions of structural units in the resulting polyester carbonate are known to those skilled in the art. These can preferably be determined by ¹H NMR. This method is known to those skilled in the art. The polyester can for example be dissolved in CDCl₃ and the corresponding peaks in the structural units identified. The ratios and proportions can be determined via the integrals.

According to the invention, at least one cycloaliphatic dicarboxylic acid is likewise used in step (i) of the process. The at least one cycloaliphatic dicarboxylic acid is preferably selected from a compound of the chemical formula (IIa), (IIb) or mixtures thereof

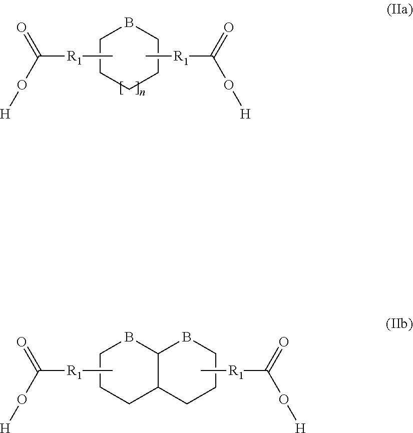

where

B in each case independently represents a CH₂ group or a heteroatom selected from the group consisting of O and S, preferably a CH₂ group or an oxygen atom,

R₁ in each case independently represents a single bond or an alkylene group having 1 to 10 carbon atoms, preferably a single bond or an alkylene group having 1 to 5 carbon atoms, more preferably a single bond, and

n is a number between 0 and 3, preferably 0 or 1.

When R₁ represents a single bond, it will be appreciated that R₁ accordingly contains zero carbon atoms.

The at least one cycloaliphatic dicarboxylic acid is in particular preferably selected from the group consisting of cyclohexane-1,4-dicarboxylic acid, cyclohexane-1,3-dicarboxylic acid, cyclohexane-1,2-dicarboxylic acid, tetrahydrofuran-2,5-dicarboxylic acid, tetrahydrodimethylfuran-2,5-dicarboxylic acid, decahydronaphthalene-2,4-dicarboxylic acid, decahydronaphthalene-2,5-dicarboxylic acid, decahydronaphthalene-2,6-dicarboxylic acid, and decahydronaphthalene-2,7-dicarboxylic acid. It is also possible to use any desired mixtures. Very particularly preferably, it is cyclohexane-1,4-dicarboxylic acid, cyclohexane-1,3-dicarboxylic acid or cyclohexane-1,2-dicarboxylic acid.

In addition to the cycloaliphatic acid, small amounts of further aliphatic acids may also be used. In process step (i) it is particularly preferable that a further aliphatic acid that is not a cycloaliphatic acid is additionally present in a content of up to 20 mol %, more preferably up to 10 mol %, and very particularly preferably up to 5 mol %. The further aliphatic acid is preferably selected from the group consisting of 2,2,4-trimethyladipic acid, 2,4,4-trimethyladipic acid, 2,2,5-trimethyladipic acid, and 3,3-dimethylglutaric acid.

According to the invention, at least one diaryl carbonate is also used in process step (i). The at least one diaryl carbonate is preferably selected from the group consisting of a compound of formula (2)

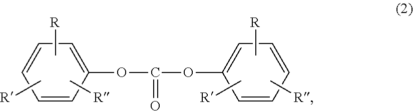

where

R, R′, and R″ may each independently be identical or different and represent hydrogen, optionally branched C1-C34 alkyl, C7-C34 alkylaryl, C6-C34 aryl, a nitro group, a carbonyl-containing group, a carboxyl-containing group or a halogen group. Preferably, R, R′, and R″ are each independently identical or different and represent hydrogen, optionally branched C1-C34 alkyl, C7-C34 alkylaryl, C6-C34 aryl, a nitro group, a carbonyl-containing group, or a halogen group. The at least one diaryl carbonate is preferably diphenyl carbonate, 4-tert-butylphenyl phenyl carbonate, di(4-tert-butylphenyl) carbonate, biphenyl-4-yl phenyl carbonate, di(biphenyl-4-yl) carbonate, 4-(1-methyl-1-phenylethyl)phenyl phenyl carbonate, di[4-(1-methyl-1-phenylethyl)phenyl] carbonate, bis(methylsalicyl) carbonate, bis(ethylsalicyl) carbonate, bis(propylsalicyl) carbonate, bis(2-benzoylphenyl) carbonate, bis(phenylsalicyl) carbonate and/or bis(benzylsalicyl) carbonate. The at least one diaryl carbonate is preferably diphenyl carbonate, 4-tert-butylphenyl phenyl carbonate, di(4-tert-butylphenyl) carbonate, biphenyl-4-yl phenyl carbonate, di(biphenyl-4-yl) carbonate, 4-(1-methyl-1-phenylethyl)phenyl phenyl carbonate, di[4-(1-methyl-1-phenylethyl)phenyl] carbonate, bis(2-benzoylphenyl) carbonate, bis(phenylsalicyl) carbonate and/or bis(benzylsalicyl) carbonate. In particular, the at least one diaryl carbonate is preferably diphenyl carbonate, 4-tert-butylphenyl phenyl carbonate, di(4-tert-butylphenyl) carbonate, biphenyl-4-yl phenyl carbonate, di(biphenyl-4-yl) carbonate, 4-(1-methyl-1-phenylethyl)phenyl phenyl carbonate and/or di[4-(1-methyl-1-phenylethyl)phenyl] carbonate. The at least one diaryl carbonate is particularly preferably diphenyl carbonate.

In addition, at least one catalyst is according to the invention present in step (i) of the process. This is preferably an inorganic base and/or an organic catalyst. The at least one catalyst is particularly preferably an inorganic or organic base having a pK_{b} of not more than 5.

It is also preferable that the at least one inorganic base or the at least one organic catalyst is selected from the group consisting of the hydroxides, carbonates, halides, phenoxides, diphenoxides, fluorides, acetates, phosphates, hydrogen phosphates and borates of lithium, sodium, potassium, cesium, calcium, barium, and magnesium, tetramethylammonium hydroxide, tetramethylammonium acetate, tetramethylammonium fluoride, tetramethylammonium tetraphenylborate, tetraphenylphosphonium fluoride, tetraphenylphosphonium tetraphenylborate, dimethyldiphenylammonium hydroxide, tetraethylammonium hydroxide, cetyltrimethylammonium tetraphenylborate, cetyltrimethylammonium phenoxide, diazabicycloundecene (DBU), diazabicyclononene (DBN), 1,5,7-triazabicyclo[4.4.0]dec-5-ene, 7-phenyl-1,5,7-triazabicyclo[4.4.0]dec-5-ene, 7-methyl-1,5,7-triazabicyclo[4.4.0]dec-5-ene, 7,7′-hexylidenedi-1,5,7-triazabicyclo[4.4.0]dec-5-ene, 7,7′-decylidenedi-1,5,7-triazabicyclo[4.4.0]dec-5-ene, 7,7′-dodecylidenedi-1,5,7-triazabicyclo[4.4.0]dec-5-ene, the phosphazene base P1-t-oct (tert-octyliminotris(dimethylamino)phosphorane), the phosphazene base P1-t-butyl (tert-butyl-iminotris(dimethylamino)phosphorane), and 2-tert-butylimino-2-diethylamino-1,3-dimethylperhydro-1,3,2-diaza-2-phosphorane (BEMP). It is also possible to use any desired mixtures.

The at least one catalyst is particularly preferably an organic base, preferably those mentioned above, very particularly preferably alkylamines, imidazole (derivatives), guanidine bases such as triazabicyclodecene, DMAP, and corresponding derivatives, DBN and DBU, most preferably DMAP. These catalysts have the particular advantage that, in step (ii) of the process of the invention, they can be removed with the chemical compound eliminated in the condensation, for example under reduced pressure. This means that the resulting polyester carbonate contains minimal residual catalyst or none at all. This has the particular advantage that no inorganic salts are present in the polymer, as are always formed, for example, in any route in which phosgene is used. It is known that such salts can have an adverse effect on the stability of the polyester carbonate, since the ions can act catalytically with corresponding degradation.

Preference is given to using the at least one catalyst in amounts from 1 to 5000 ppm, preferably 5 to 1000 ppm and more preferably 20 to 200 ppm, based on 1 mol of the cycloaliphatic dicarboxylic acid.

In another embodiment, the process of the invention is characterized in that the reaction in process step (i) is carried out in the presence of at least one first catalyst and/or a second catalyst and that the condensation in process step (ii) is carried out at least in the presence of the first catalyst and the second catalyst, wherein the first catalyst is at least one tertiary nitrogen base, the second catalyst is at least one basic compound, preferably a basic alkali metal salt, and wherein the proportion of alkali metal cations in process step (ii) is 0.0008% to 0.0050% by weight based on all the components used in process step (i).

In this embodiment, a first catalyst and/or a second catalyst is therefore present in process step (i).

The first catalyst is a tertiary nitrogen base. This first catalyst is preferably selected from bases derived from guanidine, 4-dimethylaminopyridine (DMAP), 1,8-diazabicyclo[5.4.0]undec-7-ene, 1,5-diazabicyclo[4.3.0]non-5-ene, 1,5,7-triazabicyclo[4.4.0]dec-5-ene, hexamethylphosphorimide triamide 1,2-dimethyl-1,4,5,6-tetrahydropyridine, 7-methyl-1,5,7-triazabicyclodec-5-ene, 1,8-diazabicyclo[5.4.0]undec-7-ene (DBU), DBN, ethylimidazole, N,N-diisopropylethylamine (Hunig's base), pyridine, TMG, and mixtures of these substances. Further preferably, the first catalyst is selected from bases derived from guanidine, 4-dimethylaminopyridine (DMAP), 1,8-diazabicyclo[5.4.0]undec-7-ene, 1,5-diazabicyclo[4.3.0]non-5-ene, and 1,5,7-triazabicyclo[4.4.0]dec-5-ene. Particular preference is given to using 4-dimethylaminopyridine.

The first catalyst is preferably used in an amount of from 0.002% to 0.10% by weight, more preferably in an amount of from 0.005% to 0.050% by weight, particularly preferably in an amount of from 0.008% to 0.030% by weight, in each case based on all components used in process step (i).

It is preferable that the second catalyst is selected from the group consisting of inorganic or organic alkali metal salts and inorganic or organic alkaline earth metal salts. More preferably, the alkali metal cations present in process step (ii) are lithium cations, potassium cations, sodium cations, cesium cations, and mixtures thereof.

The second catalyst used is the organic or inorganic alkali metal or alkaline earth metal salt preferably of a weak acid (pKa between 3 and 7 at 25° C.). Suitable weak acids are for example carboxylic acids, preferably C2-C22 carboxylic acids, such as acetic acid, propionic acid, oleic acid, stearic acid, lauric acid, benzoic acid, 4-methoxybenzoic acid, 3-methylbenzoic acid, 4-tert-butylbenzoic acid, p-tolueneacetic acid, 4-hydroxybenzoic acid, salicylic acid, partial esters of polycarboxylic acids, such as monoesters of succinic acid, branched aliphatic carboxylic acids, such as 2,2-dimethylpropanoic acid, 2,2-dimethylpropanoic acid, 2,2-dimethylbutanoic acid, and 2-ethylhexanoic acid. However, it is also possible that the organic or inorganic alkali metal salt or alkaline earth metal salt of a strong acid such as hydrochloric acid is used.

Suitable organic and inorganic salts are or are derived from sodium hydrogen carbonate, potassium hydrogen carbonate, lithium hydrogen carbonate, sodium carbonate, lithium carbonate, potassium carbonate, sodium acetate, potassium acetate, lithium acetate, sodium stearate, potassium stearate, lithium stearate, sodium oleate, lithium oleate, potassium oleate, sodium benzoate, potassium benzoate, lithium benzoate, and the disodium, dipotassium, and dilithium salts of BPA. It is also possible to use calcium hydrogen carbonate, barium hydrogen carbonate, magnesium hydrogen carbonate, strontium hydrogen carbonate, calcium carbonate, barium carbonate, magnesium carbonate, strontium carbonate, calcium acetate, barium acetate, magnesium acetate, strontium acetate, calcium stearate, barium stearate, magnesium stearate and corresponding oleates. The use of corresponding salts of phenols, in particular of phenol, is additionally possible. These salts may be used individually or in a mixture.

The second catalyst is preferably selected from the group consisting of sodium hydroxide, lithium hydroxide, sodium phenoxide, lithium phenoxide, sodium benzoate, lithium benzoate, lithium chloride, lithium acetylacetonate, and cesium carbonate and mixtures of these substances. Particular preference is given to using sodium phenoxide, lithium phenoxide, sodium hydroxide, lithium hydroxide, sodium benzoate, lithium benzoate, lithium chloride and/or lithium acetylacetonate. Lithium chloride is preferably used as an aqueous solution, for example in the form of a 15% solution.

It was found that the molar ratio of all aliphatic dihydroxy compounds present in process step (i) to all cycloaliphatic dicarboxylic acids present in process step (i) prior to the reaction in process step (i) is preferably 1:0.6 to 1:0.05, more preferably 1:0.5 to 1:0.15, and very particularly preferably 1:0.4 to 1:0.2

In order to achieve particularly favorable mechanical properties, good chemical resistance, and good processing properties, the ratio of aliphatic dihydroxy compounds and cycloaliphatic dicarboxylic acids in the subsequent polyester carbonate should preferably not be too high (i.e. content of incorporated cycloaliphatic dicarboxylic acids not too low). Polymers having a high content of units derived from dihydroxy compounds such as isosorbide are usually very rigid and consequently have inadequate mechanical properties. If the content of units derived from cycloaliphatic dicarboxylic acids is too low, the processability of the resulting polymers will likewise be poorer. In addition, polyester units generally give the polyester carbonate better chemical stability, which is why the content of units derived from cycloaliphatic dicarboxylic acids should likewise not be too low.

According to the invention, it is preferable that the polyester carbonate produced has a relative solution viscosity eta rel of greater than 1.22, likewise preferably 1.25 to 1.65, particularly preferably 1.28 to 1.63, very particularly preferably 1.30 to 1.62. It is preferable here that the relative solution viscosity is measured in dichloromethane at a concentration of 5 g/l at 25° C. using an Ubbelohde viscometer. Those skilled in the art are familiar with the determination of relative solution viscosity using an Ubbelohde viscometer. This is in accordance with the invention preferably carried out in accordance with DIN 51562-3; 1985-05. In this determination, the transit times of the polyester carbonate under investigation are measured by the Ubbelohde viscometer in order to then determine the difference in viscosity between the polymer solution and its solvent. For this, the Ubbelohde viscometer undergoes an initial calibration through measurement of the pure solvents dichloromethane, trichloroethylene, and tetrachlorethylene (always performing at least 3 measurements, but not more than 9 measurements). This is followed by the calibration proper with the solvent dichloromethane. The polymer sample is then weighed out, dissolved in dichloromethane and the flow time for this solution then determined in triplicate. The average of the flow times is corrected via the Hagenbach correction and the relative solution viscosity calculated.

In accordance with the invention, these molar masses are preferably referred to as “sufficient” molar mass. According to the invention, it is particularly preferable that the molar ratio of all aliphatic dihydroxy compounds present in step (i) of the process to all cycloaliphatic dicarboxylic acids present in step (i) of the process prior to the reaction in step (i) of the process is 1:0.6 to 1:0.05, preferably 1:0.55 to 1:0.1, more preferably 1:0.5 to 1:0.15. It has in accordance with the invention been found that the increase in molecular weight and thus surface renewal is particularly good in this range in particular.

According to the invention, it is particularly advantageous when, in the process of the invention,
60 to 90 parts of isosorbide, preferably 65-85 parts of isosorbide, or isosorbide isomer
40 to 10 parts of cycloaliphatic dicarboxylic acid, preferably 35-15 parts of cycloaliphatic dicarboxylic acid, preferably cyclohexane-1,4-dicarboxylic acid

2 to 25 mol %, preferably 3 to 20 mol %, particularly preferably 4 to 18 mol % of isosorbide are replaced by the at least one further aliphatic diol, in particular linear, very preferably branched diol having 2 to 10 carbon atoms. The total amount of the at least one aliphatic diol in the overall composition is here preferably less than 20 mol %, in particular less than 15 mol %.

The process of the invention is characterized in that carbon dioxide is released during the process. According to the invention, carbon dioxide is preferably eliminated in process step (i) (see reaction scheme above). This procedure permits a swift reaction with low thermal stress.

In addition, process step (i) of the invention preferably comprises at least one, more preferably all of the following steps (ia) to (ic):

(ia) Melting of all components present in step (i) of the process, i.e. at least the at least one cycloaliphatic dicarboxylic acid, the at least one diaryl carbonate, and at least components (A) and (B) in the presence of the at least one catalyst. This is preferably done under an inert gas atmosphere, preferably under nitrogen and/or argon. Step (ia) is preferably carried out in the absence of solvent. The term “solvent” is in this context known to those skilled in the art. The term “solvent” is according to the invention preferably understood as meaning a compound that does not undergo chemical reaction in either of process steps (i) and (ii). Exceptions are those compounds that are formed by the reaction (for example phenol when diphenyl carbonate is used as the at least one diaryl carbonate). It is of course not possible to rule out the presence of traces of solvents in the starting compounds. This eventuality is preferably to be covered by the invention. However, it is according to the invention preferable that an active step of adding such a solvent is avoided.

(ib) Heating of the mixture, preferably the melt obtained from step (ia). Step (ia) and step (ib) may also overlap, since heating may likewise be necessary to produce a melt in step (ia). Heating is preferably initially to a temperature of 150° C. to 180° C.

(ic) Reacting the mixture, preferably the mixture obtained from step (ib), with introduction of mixing energy, preferably by stirring. Here too, step (ic) may overlap with step (ib), since the heating may already initiate the reaction of the mixture. The melt is here preferably already heated under standard pressure to temperatures between 150 and 180° C. by step (ib). Depending on the selected catalyst, the temperature can remain within a range of 160-200° C. Alternatively, the temperature in step (ic) is increased to 200° C.-300° C., preferably 210-260° C., more preferably 215-240° C., in stages, depending on the observed reactivity. The reactivity can be estimated from the evolution of gas, in a manner known to those skilled in the art. Although higher temperatures are in principle also possible in this step, side reactions (e.g. discoloration) can occur at higher temperatures. Higher temperatures are therefore less preferable. The mixture is stirred under standard pressure until the evolution of gas has largely ceased. It is in accordance with the invention possible that under these conditions the aryl alcohol formed by the reaction of the at least one carboxylic acid with the at least one diaryl carbonate (for example phenol when using diphenyl carbonate) will already be partly removed.

It was also in accordance with the invention observed that at least one of the dihydroxy compounds (A) and/or (B) had likewise already begun to react by this time. This was demonstrated by the detection of oligomers containing carbonate units from the reaction of at least one of dihydroxy compounds (A) and/or (B) with the at least one diaryl carbonate and/or with ester units from the reaction of at least one of dihydroxy compounds (A) and/or (B) with the at least one dicarboxylic acid.

It is therefore preferable according to the invention that, prior to the performance of process step (ii), the mixture obtained from process step (i) includes oligomers containing carbonate units from the reaction of at least one of the dihydroxy compounds (component (A) and/or (B)) with the at least one diaryl carbonate and/or with ester units from the reaction of at least one of the dihydroxy compounds (component (A) and/or (B)).

The reaction time in step (ic) depends on the amount of the starting materials. Preferably, the reaction time in step (ic) is between 0.5 h to 24 h, preferably between 0.75 h and 5 h, and particularly preferably between 1 h and 3 h. A reaction time that ensures that gas evolution has largely subsided should preferably be chosen (see reaction scheme above).

According to the invention, it is preferable that the molar ratio of the sum of all dihydroxy compounds present in step (i) of the process and all cycloaliphatic dicarboxylic acids present in step (i) of the process to all diaryl carbonates present in step (i) of the process prior to the reaction in step (i) of the process is 1:0.4 to 1:1.6, preferably 1:0.5 to 1:1.5, further preferably 1:0.6 to 1:1.4, more preferably 1:0.7 to 1:1.3, particularly preferably 1:0.8 to 1:1.2 and very particularly preferably 1:0.9 to 1:1.1. Those skilled in the art are capable of selecting appropriate optimal ratios in line with the purity of the starting materials.

Process Step (ii)

In process step (ii), the mixture obtained from process step (i) undergoes further condensation, at least with removal of the chemical compound eliminated in the condensation. In the context of the invention, the expression “further” condensation is to be understood as meaning that at least some condensation has already taken place in process step (i). This is preferably the reaction of the at least one cycloaliphatic dicarboxylic acid with the at least one diaryl carbonate accompanied by elimination of an aryl alcohol. It is however preferable that further condensation to oligomers has also already taken place (see process step (i)).

When only the first catalyst or only the second catalyst was used in process step (i), the catalyst not used in process step (i) is added in process step (ii).

The proportion of alkali metal cations in process step (ii) is preferably from 0.0009% to 0.0005% by weight and more preferably from 0.0010% to 0.0045% by weight, in each case based on all components used in process step (i).

In a preferred embodiment, the first catalyst and the second catalyst are present in process step (i).

It is also possible to use a portion of the first catalyst and/or a portion of the second catalyst in process step (i) and then use the remainder in process step (ii).

It is however preferable for the total amount of the first and/or of the second catalyst to be used in process step (i). Most preferably, the total amount of both catalysts is used in process step (i).

The term “condensation” is known to those skilled in the art. This is preferably understood as meaning a reaction in which two molecules (of the same substance or different substances) combine to form a larger molecule, with a molecule of a chemically simple substance being eliminated. This compound eliminated in the condensation is removed in process step (ii). It is preferable that the chemical compound eliminated in the condensation is removed in process step (ii) by means of reduced pressure. It is accordingly preferable that the process of the invention is characterized in that volatiles having a boiling point below the cycloaliphatic diester formed in process step (i), below the mixture of dihydroxy compounds, and below the at least one diaryl carbonate are removed during the reaction in process step (i), optionally accompanied by a stepwise reduction in pressure. Removal in stages is the preferred option here when different volatiles are being removed. Opting for removal in stages is also preferred in order to ensure that volatiles are removed as completely as possible. The volatiles are the chemical compound(s) eliminated in the condensation.

Reducing the pressure in stages can be done for example by lowering the pressure as soon as the overhead temperature falls, so as to ensure continuous removal of the chemical compound eliminated in the condensation. Once a pressure of 1 mbar, preferably <1 mbar, has been reached, the condensation is continued until the desired viscosity has been attained. This can be done for example by monitoring the torque, i.e. the polycondensation is stopped on attaining the desired stirrer torque.

The removal of the condensation product in process step (ii) preferably takes place at temperatures of 200° C. to 280° C., more preferably 210° C. to 260° C., and particularly preferably 220° C. to 250° C. The pressure during the removal is further preferably 500 mbar to 0.01 mbar. It is particularly preferable for removal to be effected in stages by reducing the pressure. Very particularly preferably, the vacuum in the final stage is 10 mbar to 0.01 mbar.

In a further aspect of the present invention, a polyester carbonate is provided that is obtained by the above-described process of the invention in all disclosed combinations and preferences. The polyester carbonate of the invention can be processed as such into moldings of all kinds. It can also be processed into thermoplastic molding compounds with other thermoplastics and/or polymer additives. The molding compounds and moldings are further provided by the present invention.

The polymer additives are preferably selected from the group consisting of flame retardants, anti-drip agents, flame retardant synergists, smoke inhibitors, lubricants and demolding agents, nucleating agents, antistats, conductivity additives, stabilizers (e.g. hydrolysis, heat aging and UV stabilizers and also transesterification inhibitors), flow promoters, phase compatibilizers, dyes and pigments, impact modifiers and also fillers and reinforcers.

The thermoplastic molding materials of the invention may be produced for example by mixing the polyester carbonate and the other constituents and melt-compounding and melt-extruding the resulting mixture at temperatures of preferably 200° C. to 320° C. in customary apparatuses, for example internal kneaders, extruders and twin-shaft screw systems, in a known manner. This process is referred to in the context of the present application generally as compounding.

The term “molding compound” is thus to be understood as meaning the product obtained when the constituents of the composition are melt-compounded and melt-extruded.

The moldings obtained from the polyester carbonate of the invention or from the thermoplastic molding compounds comprising the polyester carbonate can be produced for example by injection molding, extrusion, and blow-molding processes. A further form of processing is the production of moldings by thermoforming from previously produced sheets or films.

### EXAMPLES

Materials Used:

Cyclohexanedicarboxylic acid: Cyclohexane-1,4-dicarboxylic acid; CAS 1076-97-7 99%; Tokyo Chemical Industries, Japan, abbreviated to CHDA. The CHDA contained less than 1 ppm sodium by elemental analysis.

Diphenyl carbonate: Diphenyl carbonate, 99.5%, CAS 102-09-0; Acros Organics, Geel, Belgium, abbreviated to DPC

4-Dimethylaminopyridine: 4-Dimethylaminopyridine; ≥98.0%; purum; CAS 1122-58-3; Sigma-Aldrich, Munich, Germany, abbreviated to DMAP

Isosorbide: Isosorbide (CAS: 652-67-5), 99.8%, Polysorb PS A; Roquette Freres (62136 Lestrem, France); abbreviated to ISB

Lithium hydroxide monohydrate (CAS: 1310-66-3); >99.0%; Sigma-Aldrich

2-Butyl-2-ethylpropane-1,3-diol: CAS No. 115-84-4; Aldrich (abbreviated to BEPD)

2,2,4,4-Tetramethylcyclobutane-1,3-diol: 98% (CAS: 3010-96-6); ABCR (abbreviated to TMCBD)

2,2,4-Trimethylpentane-1,3-diol; CAS No.: 144-19-4; Aldrich (abbreviated to TMPD)

Neopentyl glycol (2,2-dimethylpropane-1,3-diol); CAS: 126-30-7; Aldrich (abbreviated to NPG)

Butane-1,4-diol: CAS: 110-63-4; Merck 99%; (abbreviated to BDO)

Cyclohexane-1,4-dimethanol CAS: 105-08-8, Aldrich 99% (abbreviated to CHDM)

Dodecane-1,12-diol: CAS: 5675-51-4, Aldrich 99% (abbreviated to DDD)

Analytical Methods:

Solution Viscosity

The relative solution viscosity (ηrel; also referred to as eta rel) was determined in dichloromethane at a concentration of 5 g/l at 25° C. using an Ubbelohde viscometer. The determination was carried out in accordance with DIN 51562-3; 1985-05. In this determination, the transit times of the polyester carbonate under investigation are measured by the Ubbelohde viscometer in order to then determine the difference in viscosity between the polymer solution and its solvent. For this, the Ubbelohde viscometer undergoes an initial calibration through measurement of the pure solvents dichloromethane, trichloroethylene, and tetrachlorethylene (always performing at least 3 measurements, but not more than 9 measurements). This is followed by the calibration proper with the solvent dichloromethane. The polymer sample is then weighed out, dissolved in dichloromethane and the flow time for this solution then determined in triplicate. The average of the flow times is corrected via the Hagenbach correction and the relative solution viscosity calculated.

Determination of the Glass Transition Temperature

The glass transition temperature was determined by differential scanning calorimetry (DSC) in accordance with standard DIN EN ISO 11357-1:2009-10 and ISO 11357-2:2013-05 at a heating rate of 10 K/min under nitrogen with determination of the glass transition temperature (Tg) measured as the point of inflection in the second heating run. MALDI-TOF-MS

The sample was dissolved in chloroform. The matrix used was Dithranol with LiCl. The sample was analyzed in positive reflector and linear modes.

### Comparative Example 1 (Experiment without Additional Diol)

A flask with a short-path separator was charged with 17.20 g (0.10 mol) of cyclohexane-1,4-dicarboxylic acid, 29.83 g (0.204 mol) of isosorbide, 64.30 g (0.3 mol) of diphenyl carbonate, 0.0111 g of DMAP (4-dimethylaminopyridine; 100 ppm based on the starting materials CHDA, DPC, and ISB), and 115 l of an aqueous solution of lithium hydroxide (100 g/1), corresponding to approx. 30 ppm Li. The mixture was freed of oxygen by evacuating and releasing the vacuum with nitrogen four times. The mixture was melted and heated to 160° C. at standard pressure with stirring. The mixture was stirred at 160° C. for 40 minutes, at 175° C. for 60 minutes, at 190° C. for 30 minutes, and at 205° C. for 10 minutes. During this operation, carbon dioxide was continuously evolved. On cessation of CO₂ evolution, the bath temperature was adjusted to 220° C. After a further 20 minutes, a negative pressure was applied. The pressure was lowered to 10 mbar over a 30-minute period. During this operation, phenol was continuously removed. The mixture was stirred at 10 mbar for about 10 minutes. The pressure was then lowered to <1 mbar (approx. 0.7 mbar) and the condensation continued for a further 10 minutes. Processing of the mixture was then stopped.

A light yellow polymer having a solution viscosity of eta rel 1.33 was obtained.

The other examples (Ex.) and comparative examples (Comp.) were carried out as stated for comparative example 1. In a departure from example 1, the aliphatic diols specified in Table 1 were also placed in the flask with a short-path separator together with all the other monomers forming the polymer and the catalyst.

TABLE 1

| | Comp. | Inv. | Inv. | Inv. | Inv. | Inv. | Inv. | Inv. | Inv. |
|---|---|---|---|---|---|---|---|---|---|
| | 1 | 1 | 2 | 3 | 4 | 5 | 6 | 7 | 8 |
| Molar ratio | 33/67/0 | 33/64/3 | 33/60/7 | 33/57/10 | 33/64/3 | 33/57/10 | 33/60/7 | 33/64/3 | 33/64/3 |
| CHDA/ISB/ | | | | | | | | | |
| HO—R—OH | | | | | | | | | |
| Ratio total | approx. | approx. | approx. | approx. | approx. | approx. | approx. | approx. | approx. |
| diols:CHDA | 1:0.5 | 1:0.5 | 1:0.5 | 1:0.5 | 1:0.5 | 1:0.5 | 1:0.5 | 1:0.5 | 1:0.5 |
| mol % | 0 | 5 | 10 | 15 | 5 | 15 | 10 | 5 | 5 |
| HO—R—OH | | | | | | | | | |
| CHDA (mol) | 0.1 | 0.2 | 0.2 | 0.2 | 0.2 | 0.2 | 0.1 | 0.1 | 0.1 |
| approx. | | | | | | | | | |
| HO—R—OH | 0 | 0.02 | 0.04 | 0.06 | 0.02 | 0.06 | 0.02 | 0.01 | 0.01 |
| approx. | | TMPD | TMPD | TMPD | NPG | NPG | BEPD | BEPD | TMCBD |
| (mol) | | | | | | | | | |
| DPC (mol) | 0.3 | 0.6 | 0.6 | 0.6 | 0.6 | 0.6 | 0.3 | 0.3 | 0.3 |
| approx. | | | | | | | | | |
| ISB (mol) | 0.2 | 0.38 | 0.36 | 0.34 | 0.38 | 0.34 | 0.18 | 0.19 | 0.19 |
| approx. | | | | | | | | | |
| Eta rel | 1.33 | 1.383 | 1.362 | 1.647 | 1.413 | 1.446 | 1.501 | 1.474 | 1.434 |
| Glass | 151 | 144 | 146 | 138 | 150 | 147 | 133 | 142 | 154 |
| transition | | | | | | | | | |
| temperature | | | | | | | | | |
| in ° C. | | | | | | | | | |

| | Inv. | Inv. | Inv. | Inv. | Comp. | Comp. | Comp. |
|---|---|---|---|---|---|---|---|
| | 9 | 10 | 11 | 12 | 2 | 3 | 4 |
| Molar ratio | 33/57/10 | 33/64/3 | 33/64/3 | 33/57/10 | 33/33.5/33.5 | 33/33.5/33.5 | 33/33.5/33.5 |
| CHDA/ISB/ | | | | | | | |
| HO—R—OH | | | | | | | |
| Ratio total | approx. | approx. | approx. | approx. | approx. | approx. | approx. |
| diols:CHDA | 1:0.5 | 1:0.5 | 1:0.5 | 1:0.5 | 1:0.5 | 1:0.5 | 1:0.5 |
| mol % | 15 | 5 | 5 | 15 | 50 | 50 | 50 |
| HO—R—OH | | | | | | | |
| CHDA (mol) | 0.1 | 0.1 | 0.1 | 0.1 | 0.1 | 0.1 | 0.1 |
| approx. | | | | | | | |
| HO—R—OH | 0.03 | 0.01 | 0.01 | 0.03 | 0.1 | 0.1 | 0.1 |
| approx. | TMCBD | BDO | CHDM | DDD | TMPD | NPG | DDD |
| (mol) | | | | | | | |
| DPC (mol) | 0.3 | 0.3 | 0.3 | 0.3 | 0.3 | 0.3 | 0.3 |
| approx. | | | | | | | |
| ISB (mol) | 0.17 | 0.19 | 0.19 | 0.17 | 0.1 | 0.1 | 0.1 |
| approx. | | | | | | | |
| Eta rel | 1.606 | 1.396 | 1.41 | 1.301 | 1.094 | 1.119 | 1.149 |
| Glass | 153 | 145 | 145 | 94 | 94 | 84 | gel-like |
| transition | | | | | | | at room |
| temperature | | | | | | | temperature |
| in ° C. | | | | | | | |

The mol data in the second column of Table 1 are reported as “approx.”, since they were rounded to the second decimal place. The ratio 2.04:1.00 (diols to diacids) served as a basis.

Examples 1 to 12 according to the invention show that the process of the invention afforded the desired polyester carbonate in high viscosities provided the amounts of additional diol according to the invention are observed. It can be seen here that the addition of a further aliphatic diol, especially of branched diols, causes the molecular weight to rise significantly in relation to an example in which no further aliphatic diol is present (see comparative example 1). Better miscibility was observed at higher temperatures, which meant it was possible for a further increase in molecular weight to take place. When an excessive amount of additional diol is used (see comparative examples 2 to 4), the increase in molecular weight is markedly lower.

### Example 13 According to the Invention: Reaction in Step (i) of the Process

A flask with a short-path separator was charged with 0.10 mol of cyclohexane-1,4-dicarboxylic acid, 0.02 mol of BEPD (10%), and 0.18 mol of isosorbide and also 0.3 mol of diphenyl carbonate and 100 ppm of DMAP (4-dimethylaminopyridine; based on the starting materials CHDA, BEPD, DPC, and ISB) and also 0.0763 ml of an aqueous solution of lithium hydroxide (100 g/l), corresponding to approx. 20 ppm Li. The mixture was freed of oxygen by evacuating and releasing the vacuum with nitrogen four times. The mixture was heated gradually to 190° C. During this operation, carbon dioxide was continuously evolved. A 3 mL sample was then taken and analyzed by MALDI-TOF-MS. To ensure that the batch continued to polymerize, the reaction was heated to 220° C. and the pressure then gradually reduced to <1 mbar. An increase in viscosity was observed.

The results of the analysis are summarized in Table 2. The respective masses correspond to the Li adduct M+Li*. Various peaks were identified in which not only the ISB but also the BEPD could have reacted. This is a clear indication that the isosorbide and the BEPD already react under the process conditions of process step (i). In Table 2, ISB denotes an isosorbide unit minus the two terminal OH groups (these are described separately), CHDA stands for cyclohexane (cyclohexanedicarboxylic acid minus the two carboxylic acid groups), and BEPD stands for 2-butyl-2-ethylpropane-1,3-diol minus the two OH groups.

TABLE 2

| Peaks in the | |
|---|---|
| MALDI-TOF | |
| spectrum | Possible structure |
| 383 Da | HO-ISB-ester-CHDA-ester-phenyl |
| 397 Da | HO-BEPD-ester-CHDA-ester-phenyl |
| 512 Da | HO-ISB-carbonate-ISB-carbonate-BEPD-OH |
| 555 Da | HO-ISB-carbonate-ISB-ester-CHDA-ester-phenyl |
| 607 Da | HO-ISB-carbonate-ISB-ester-CHDA-ester-ISB-OH |
| 613 Da | Phenyl-ester-CHDA-ester-ISB-ester-CHDA-ester-phenyl |
| 627 Da | Phenyl-ester-CHDA-ester-BEPD-ester-CHDA-ester-phenyl |
| 665 Da | HO-ISB-ester-CHDA-ester-ISB-ester-CHDA-ester-phenyl |
| 679 Da | Phenyl-ester-CHDA-ester-ISB-ester-CHDA-ester-BEPD-OH |
| 727 Da | HO-ISB-carbonate-ISB-carbonate-ISB-ester-CHDA-ester- |
| | phenyl |
| 785 Da | Phenyl-ester-CHDA-ester-ISB-ester-CHDA-ester-ISB- |
| | carbonate-phenyl |
| 837 Da | HO-ISB-carbonate-ISB-ester-CHDA-ester-ISB-ester-CHDA- |
| | ester-phenyl |

These results suggest that the process of the invention leads to a polyester carbonate that differs from a polyester carbonate produced via a two-step process (i.e. production first of a diaryl dicarboxylate through reaction of a cycloaliphatic dicarboxylic acid with a diaryl carbonate and purification of said diaryl dicarboxylate, followed by condensation of the diaryl dicarboxylate with a diaryl carbonate and an aliphatic dihydroxy compound). It is highly likely that different statistical distributions of carbonate units and/or ester units are present in the different polyester carbonates.

1. A process for producing a polyester carbonate by melt transesterification, comprising the steps of:
(i) reacting at least one cycloaliphatic dicarboxylic acid with at least one diaryl carbonate using at least one catalyst and in the presence of a mixture of dihydroxy compounds comprising (A) at least one 1,4:3,6-dianhydrohexitol and (B) at least one further aliphatic dihydroxy compound, and
(ii) subjecting the mixture obtained from step (i) of the process to further condensation, at least with removal of the chemical compound eliminated in the condensation,
wherein the mixture of dihydroxy compounds comprises
98 mol % to 75 mol % of component (A) and
2 mol % to 25 mol % of component (B),
in each case based on the sum of components (A) and (B).

2. The process as claimed in claim 1, wherein the molar ratio of all aliphatic dihydroxy compounds present in step (i) of the process to all cycloaliphatic dicarboxylic acids present in step (i) of the process prior to the reaction in step (i) of the process is 1:0.6 to 1:05.

3. The process as claimed in claim 1, wherein the reaction in process step (i) is carried out in the presence of at least one first catalyst and/or a second catalyst and that the condensation in process step (ii) is carried out at least in the presence of the first catalyst and the second catalyst, wherein the first catalyst is at least one tertiary nitrogen base, the second catalyst is at least one basic compound, and wherein the proportion of alkali metal cations in process step (ii) is 0.0008% to 0.0030% by weight based on all the components used in process step (i).

4. The process as claimed in claim 1, wherein the at least one further aliphatic dihydroxy compound has the chemical formula (I):
HO—X—OH (I),
in which X is a linear alkylene group having 2 to 22 carbon atoms, which may optionally be interrupted by at least one heteroatom, a branched alkylene group having 4 to 20 carbon atoms, which may optionally be interrupted by at least one heteroatom, or a cycloalkylene group having 4 to 20 carbon atoms, which may optionally be interrupted by at least one heteroatom.

5. The process as claimed in claim 4, wherein the at least one further aliphatic dihydroxy compound is selected from the group consisting of cyclohexane-1,2-diol, cyclohexane-1,3-diol, cyclohexane-1,4-diol, cyclohexane-1,2-dimethanol, cyclohexane-1,3-dimethanol, cyclohexane-1,4-dimethanol, 2,2-bis(4-hydroxycyclohexyl)propane, tetrahydrofuran-2,5-dimethanol, 2-butyl-2-ethylpropane-1,3-diol, 2-(2-hydroxyethoxy)ethanol, 2,2,4,4-tetramethylcyclobutane-1,3-diol, 2,2,4-trimethylpentane-1,3-diol, 2,2-dimethylpropane-1,3-diol, cyclobutane-1,1-diyldimethanol, 8-(hydroxymethyl)-3-tricyclo[5.2.1.02,6]decanyl]methanol, propane-1,2-diol, propane-1,3-diol, butane-1,4-diol, pentane-1,5-diol, hexane-1,6-diol, octane-1,8-diol, and any desired mixtures thereof.

6. The process as claimed in claim 1, wherein the at least one 1,4:3,6-dianhydrohexitol is isosorbide.

7. The process as claimed in claim 1, wherein the at least one cycloaliphatic dicarboxylic acid is selected from a compound of the chemical formula (IIa), (IIb) or mixtures thereof 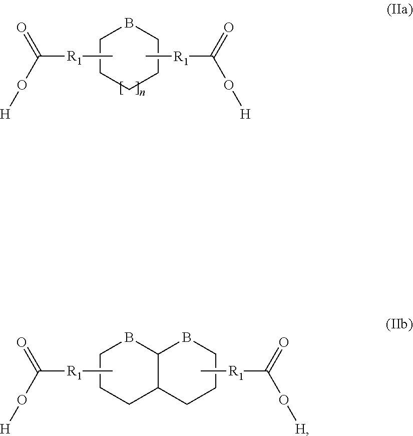
where
B in each case independently represents a CH₂ group or a heteroatom selected from the group consisting of O and S,
R₁ in each case independently represents a single bond or a linear alkylene group having 1 to 10 carbon atoms, and
n is a number between 0 and 3.

8. The process as claimed in claim 7, wherein the at least one cycloaliphatic dicarboxylic acid is selected from the group consisting of cyclohexane-1,4-dicarboxylic acid, cyclohexane-1,3-dicarboxylic acid, cyclohexane-1,2-dicarboxylic acid, tetrahydrofuran-2,5-dicarboxylic acid, tetrahydrodimethylfuran-2,5-dicarboxylic acid, decahydronaphthalene-2,4-dicarboxylic acid, decahydronaphthalene-2,5-dicarboxylic acid, decahydronaphthalene-2,6-dicarboxylic acid, and decahydronaphthalene-2,7-dicarboxylic acid.

9. The process as claimed in claim 1, wherein the at least one diaryl carbonate is selected from the group consisting of a compound of formula (2) 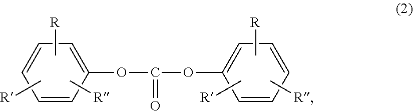
where
R, R′, and R″ may each independently be identical or different and represent hydrogen, optionally branched C1-C34 alkyl, C7-C34 alkylaryl, C6-C34 aryl, a nitro group, a carbonyl-containing group, a carboxyl-containing group or a halogen group.

10. The process as claimed in claim 3, wherein the first catalyst is selected from the group consisting of bases derived from guanidine, 4-dimethylaminopyridine, 1,8-diazabicyclo[5.4.0]undec-7-ene (DBU), 1,5-diazabicyclo[4.3.0]non-5-ene (DBN), 1,5,7-triazabicyclo[4.4.0]dec-5-ene and mixtures of these substances.

11. The process as claimed in claim 1, wherein the at least one catalyst is used in an amount of from 0.002% to 0.1% by weight based on all components used in process step (i).

12. The process as claimed in claim 3, wherein the second catalyst is selected from the group consisting of inorganic or organic alkali metal salts and inorganic or organic alkaline earth metal salts.

13. A polyester carbonate obtained by the process as claimed in claim 1.

14. A molding compound comprising a polyester carbonate as claimed in claim 13.

15. A molding comprising a polyester carbonate as claimed in claim 13.

16. The process as claimed in claim 3, wherein the second catalyst is a basic alkali metal salt.

17. The process as claimed in claim 4, wherein the cycloalkylene group contains more than one ring and may in each case optionally be branched.

18. The process as claimed in claim 1, wherein the mixture of dihydroxy compounds comprises
96 mol % to 82 mol %, of component (A) and
4 mol % to 18 mol % of component (B),
in each case based on the sum of components (A) and (B).

19. The process as claimed in claim 2, wherein the molar ratio of all aliphatic dihydroxy compounds present in step (i) of the process to all cycloaliphatic dicarboxylic acids present in step (i) of the process prior to the reaction in step (i) of the process is 1:0.5 to 1:0.15.
